(19) United States
(12) Patent Application Publication
(10) Pub. No.: US 2023/0122566 A1
(43) Pub. Date: Apr. 20, 2023

(54) LADDER STABILIZATION SYSTEM

(71) Applicants: Michael H. Heinrichs, Weymouth, MA (US); Michael R. Heinrichs, Rockland, MA (US)

(72) Inventors: Michael H. Heinrichs, Weymouth, MA (US); Michael R. Heinrichs, Rockland, MA (US)

(21) Appl. No.: 17/967,196

(22) Filed: Oct. 17, 2022

Related U.S. Application Data
(60) Provisional application No. 63/257,710, filed on Oct. 20, 2021.

(51) Int. Cl. E06C 7/18

(52) U.S. Cl. CPC E06C 7/188

(57) ABSTRACT

The invention generally relates to a stabilization system for securing and stabilizing a ladder so as to prevent unintended movement or shifting of the ladder feet during use.

### CROSS-REFERENCE TO RELATED APPLICATIONS

This application claims priority to, and the benefit of, U.S. Provisional Application No. 63/257,710, filed Oct. 20, 2021, the content of which is incorporated by reference herein in its entirety.

### FIELD OF THE INVENTION

The invention generally relates to safety devices, and, more particularly, to a stabilization system for securing and stabilizing a ladder so as to prevent unintended movement or shifting of the ladder feet during use.

### BACKGROUND

A ladder is an invaluable tool used for reaching heights that an individual could not otherwise reach. There is a seemingly endless list of activities performed at home, work, and countless other settings that require the use of an extension ladder in order to allow its user to gain access to areas that otherwise would be inaccessible. For example, some occupations, such as construction, carpentry, painting, and the like, a ladder is a necessary tool. Furthermore, it is becoming increasingly common for homeowners and renters to perform much of the maintenance around their homes, and, as a result, rely on ladders to perform such tasks.

One problem with the use of ladders though is that it accounts for one of the largest categories of injuries and fatalities for at-home and for industrial accidents. In fact, falls are the leading cause of deaths in and around the home. There are multiple reasons why ladders can be very dangerous and it nearly always involve a lack of understanding of proper use, lack of patience in proper setup for use, uneven or unstable surface for the ladder to rest upon, improper inclination of the ladder in relation to the height of the object it rests against, or any combination of the above.

Many different devices have been contemplated and used for securing a ladder in place during use. Most such devices include means for securing the upper part of a ladder against a wall, tree, or other substantially vertical surface against which the ladder leans. Other types of ladder stabilizers include may include additional legs or feet. In particular, it is common to find shoe members pivotally mounted on the feet of ladders in an effort to insure a stable base for the ladder feet which the shoes are associated, and to allow for adaptation to some of the varying parameters of terrain environment, such as varying surface contour and material composition. While these types of devices may provide some measure of additional stability, none of these devices are capable of preventing the ladder from skidding across the ground or surface at the foot of the ladder in certain hazardous conditions, such as snow and ice, or other slippery elements. Furthermore, such devices are incapable of preventing the ladder from being knocked out or tipped over in a direction away from the structure upon which the upper portion of the ladder rests.

### SUMMARY

The present invention is directed to a stabilization system for securing and stabilizing a ladder so as to prevent unintended movement or shifting of the ladder feet during use. The system includes stabilization assemblies for temporarily supporting and stabilizing respective feet of a ladder once the ladder is in a desired position relative to a support structure, such as a wall, roof, building, or the like. The stabilization assemblies are able to improve ladder safety by preventing ladders from slipped or accidentally being knocked out of position, particularly when a user is on the ladder.

In particular, each of the stabilization assemblies includes a frame member for receiving a ladder foot within and a locking member for releasably securing the ladder foot to the frame member. The frame member includes a substantially planar base member having opposing ends. Each opposing end includes one or more apertures for receiving a respective securing member therethrough. For example, during use, the base member rests upon a solid surface at the site upon which the ladder will rest, which may include soil, concrete, or wood material (i.e., decking, plywood subflooring, wood flooring, etc.). The securing member(s) may include, for example, a stake for penetrating and securing the base member to soil, grass, sand, or other outdoor ground material. Additionally or alternatively, the securing member may include a screw or other fastener for penetrating other types of solid surfaces, such as concrete, stone, or wood. Upon receiving the ladder foot within a cavity defined in the frame member, a user need only drive a stake and/or fasteners (e.g., screws or the like) through respective apertures provided at ends of the base member and into the solid surface, thereby temporarily securing the frame member to the solid surface. It should be noted that, in some embodiments, an anti-slip (also referred to as non-slip) material may be provided on a bottom surface of the base member to further prevent unintended movement of the frame member.

The frame member further includes two opposing side walls and a rear wall extending from the base member to cooperatively form a cavity shaped and sized to receive a ladder foot within. During assembly, the ladder foot rests upon the base member such that the opposing side walls and rear wall enclose and surround a portion of the ladder foot within the cavity of the frame member. The rear wall is oriented at an acute angle relative to the base member to thereby form an enclosure around the ladder foot (and any shoe attached thereto) so as to contain the ladder foot within the cavity of the frame member. As such, the cavity is essentially formed of three walls (i.e., two opposing side walls and the rear wall) and has an opening opposing the rear wall. The opening allows for the frame member to accommodate different sized ladder feet and any attached shoes. Each side wall includes a set of apertures formed in a row along an upper portion thereof and extending along a horizontal plane that is substantially parallel to the base member. The sets of apertures defined on the opposing side walls are substantially aligned with one another, such that individual apertures of the set of apertures of a left side wall are in alignment with a corresponding individual apertures of the set of apertures on a right side wall. The apertures on each side wall are configured to receive a locking member for releasably securing the ladder foot to the frame member. In particular, the locking member may include a pin, bolt, or other fastener that passes through corresponding apertures of the side walls, such that the locking member extends across the cavity and retains the ladder foot within the cavity, thereby securing the frame member to the ladder foot. In some embodiments, the locking member may include a hitch pin or other form of safety pin that is retained within the apertures via a wire snap.

Accordingly, the stabilization system of the present provides numerous advantages. The stabilization assemblies eliminate the need for someone to hold or otherwise foot the bottom of a ladder during use, and further eliminate the need for non-conventional methods to ladders in place. Furthermore, the stabilization assembly is relatively simple in design, in that the frame member is formed from a single sheet of material (preferably a rigid, durable metal, such as steel), wherein the side walls and rear walls are bent into place to thereby form the cavity. Accordingly, such a device is inexpensive to manufacture, as it requires no welding or other specific manufacturing techniques, thereby reducing the overall production costs. Furthermore, such a device is easy to install on each ladder foot. A user need only place the frame member upon a ladder foot, slide the frame member until the rear wall contacts the ladder foot, and fasten the locking member to the frame member (e.g., set a hitch pin to appropriate apertures on the side walls), thereby securing the stabilization assembly to the ladder foot. The user can then set the ladder into position at a desired site, in which the user can easily fasten the stabilization assembly to surface under the ladder. The stabilization assemblies can be temporarily secured any type of solid surface, including concrete, wood decks, soil, and the like.

### BRIEF DESCRIPTION OF THE DRAWINGS

Features and advantages of the claimed subject matter will be apparent from the following detailed description of embodiments consistent therewith, which description should be considered with reference to the accompanying drawings.

FIG. 1 is a perspective view of one embodiment of a stabilization assembly consistent with the present disclosure.

FIG. 2 is a front facing view of the stabilization assembly of FIG. 1.

FIG. 3 is a side view of the stabilization assembly of FIG. 1 illustrating a left side of the assembly.

FIG. 4 is a side view of the stabilization assembly of FIG. 1 illustrating a left side of the assembly.

FIG. 5 is a planar view of the stabilization assembly of FIG. 1.

FIG. 6 is a side view illustrating coupling of the stabilization assembly to a ladder foot.

FIG. 7 is a perspective view illustrating coupling of the stabilization assembly to a ladder foot.

FIG. 8 is a perspective view of a fastener (a stake) for securing the frame member to a surface.

FIG. 9 is a perspective view illustrating a locking member (a hitch pin) for use with the frame member in securing the frame member to a ladder foot.

FIG. 10 is a perspective view of the stabilization assembly of FIG. 1 temporarily secured to a surface via one or more fasteners.

Features and advantages of the claimed subject matter will be apparent from the following detailed description of embodiments consistent therewith, which description should be considered with reference to the accompanying drawings.

### DETAILED DESCRIPTION

The invention generally relates to safety devices, and, more particularly, to a stabilization system for securing and stabilizing a ladder so as to prevent unintended movement or shifting of the ladder feet during use. In particular, the system includes stabilization assemblies for temporarily supporting and stabilizing respective feet of a ladder once the ladder is in a desired position relative to a support structure, such as a wall, roof, building, or the like. The stabilization assemblies are able to improve ladder safety by preventing ladders from slipped or accidentally being knocked out of position, particularly when a user is on the ladder. Furthermore, the stabilization assemblies are relatively simply in design and thus easy to install, thereby making ladder safety a relatively simple endeavor.

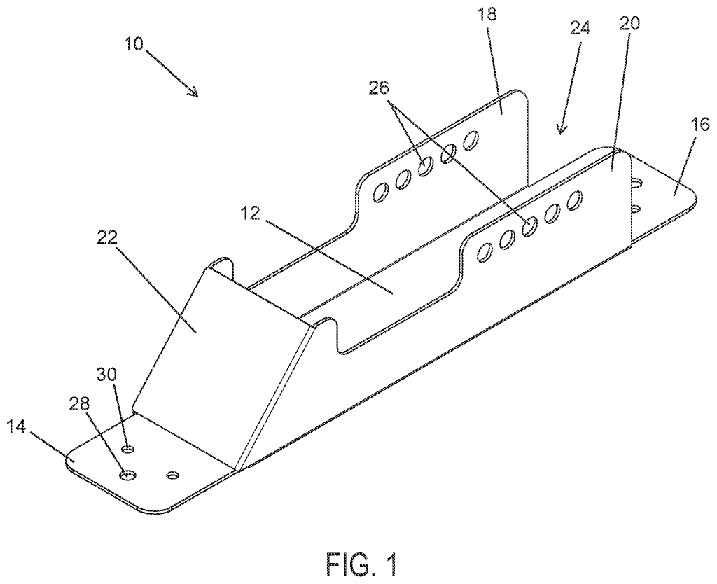

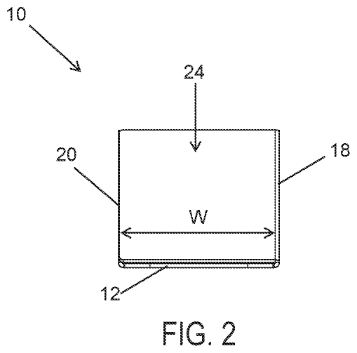

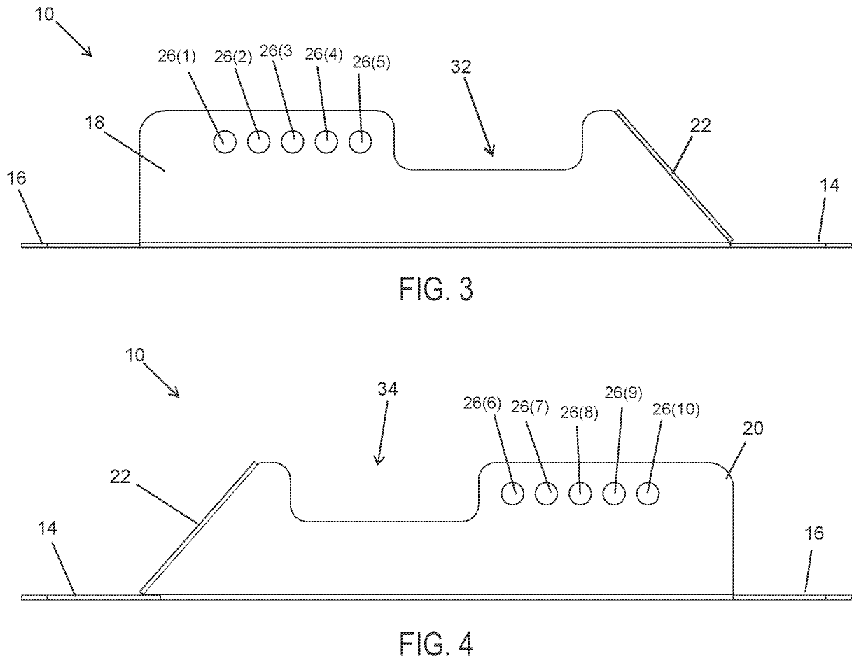

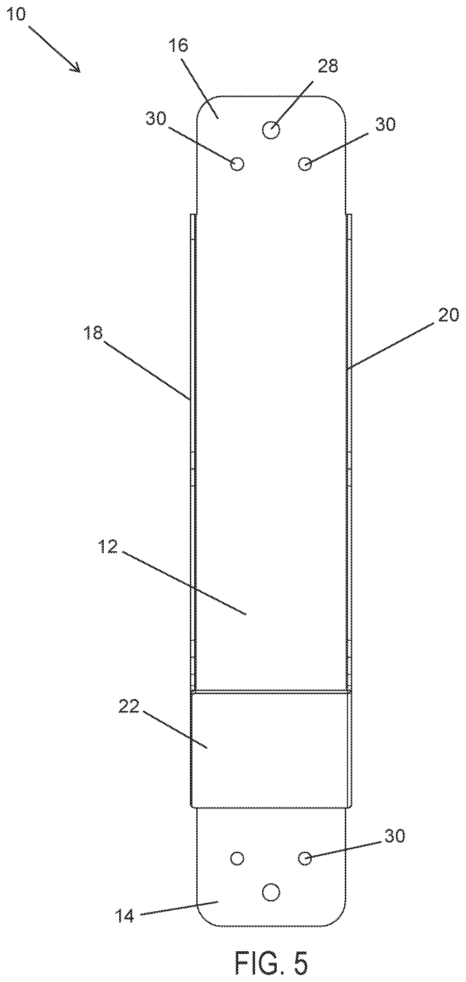

FIG. 1 is a perspective view of one embodiment of a stabilization assembly. FIG. 2 is a front facing view of the stabilization assembly, FIGS. 3 and 4 are side views of the stabilization assembly, and FIG. 5 is a planar view of the stabilization assembly.

As shown, the stabilization assembly includes a frame member 10 for receiving a ladder foot within. The frame member 10 includes a substantially planar base member 12 having opposing ends 14 and 16. The frame member 10 further includes opposing side walls (left side wall 18 and right side wall 20) and a rear wall 22 extending from the base member 12. The side walls 18 and 20 and rear wall 20 cooperatively form a cavity 24 generally shaped and sized to receive a ladder foot within. For example, during install of the frame member 12 to the bottom of a ladder, the ladder foot rests upon the base member 12 such that the opposing side walls 18 and 20 and rear wall 22 enclose and surround a portion of the ladder foot within the cavity 24.

It should be noted that the frame member 12 is relatively simple in design and manufacture, in that the frame member 10 is formed from a single sheet of material (preferably a rigid, durable metal, such as steel), wherein a pattern is cut and the side walls 18 and 20 and rear wall 22 are bent into place to thereby form the cavity 24. Accordingly, such a device is inexpensive to manufacture, as it requires no welding or other specific manufacturing techniques, thereby reducing the overall production costs.

As shown, the rear wall 22 is oriented at an acute angle relative to the base member 12. For example, the rear wall may be oriented at an angle between 30° and 70° relative to the surface of the base member 12. In some embodiments, the rear wall 22 may be oriented at angle between 45° and 60°. Yet still, in another embodiment, the rear wall 22 may be oriented at an angle of approximately 48.6°. Accordingly, the rear wall 22 forms an enclosure around the ladder foot (and any shoe attached thereto) so as to contain the ladder foot within the cavity of the frame member and generally act as a stop when installing the frame member upon a ladder foot, as described in greater detail herein.

As shown, the cavity 24 is essentially formed of three walls (i.e., two opposing side walls 18, 20 and the rear wall 22) and has an opening opposing the rear wall. The opening allows for the frame member 10 to accommodate different sized ladder feet and any attached shoes. It should be noted that the cavity 24 has a width W sized so as to accommodate most conventional ladder feet sizes. It should further be noted that each side wall 18, 20 includes a notch 32, 34 (respectively) allowing for portions of a ladder foot to extend proud of the side walls when provided within the cavity 24. For example, some ladder feet have shoes that are attached via a bolt, such that the head of the bolt sits proud of the side of the ladder rail. Accordingly, the notch 32, 34 on each side wall 18, 20 accommodates such bolts and the like.

Each side wall 18, 20 includes a set of apertures 26 formed in a row along an upper portion thereof and extending along a horizontal plane that is substantially parallel to the base member 12. The sets of apertures 26 defined on the opposing side walls are substantially aligned with one another, such that individual apertures of the set of apertures of a left side wall 18 are in alignment with a corresponding individual apertures of the set of apertures on a right side wall 20. For example, as shown in FIGS. 3 and 4, apertures 26(1) through 26(5) form a set of apertures on side wall 18 and apertures 26(6) through 26(10) form a set of apertures on side wall 20. Accordingly, apertures 26(1) and 26(6) are aligned, as are 26(2) and 26(7), as are 26(3) and 26(8), and so on. The apertures 26 on each side wall are configured to receive a locking member for releasably securing the ladder foot to the frame member 10, as will be described in greater detail herein.

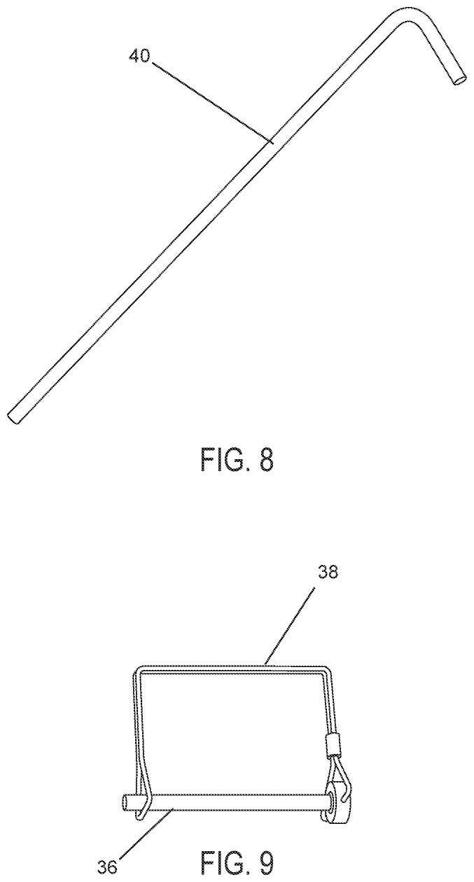

As previously described, the stabilization assembly of the present invention eliminates the need for someone to hold or otherwise foot the bottom of a ladder during use, and further eliminate the need for non-conventional methods to ladders in place. In particular, the base member 12 includes opposing ends 14 and 16, each of which includes one or more apertures (apertures 28 and 30) for receiving a respective securing member therethrough. For example, during use, the base member 12 rests upon a solid surface at the site upon which the ladder will rest, which may include soil, concrete, or wood material (i.e., decking, plywood subflooring, wood flooring, etc.). The securing member(s) may include, for example, a stake 40 (illustrated in FIG. 8) for penetrating and securing the base member 12 (and thus the frame member 10) to soil, grass, sand, or other ground material. The stake 40 may be passed through aperture 28 on each end 14 and 16, for example. Additionally or alternatively, the securing member may include a screw or other fastener for penetrating other types of solid surfaces, such as concrete, stone, or wood and thus maybe passed through apertures 30 on each end 14 and 16 of the base member 12. For example, upon receiving the ladder foot within a cavity defined in the frame member, a user need only drive a stake and/or fasteners (e.g., screws or the like) through respective apertures provided at ends of the base member and into the solid surface, thereby temporarily securing the frame member 10 to the solid surface. It should be noted that, in some embodiments, an anti-slip (also referred to as non-slip) material may be provided on a bottom surface of the base member 12 to further prevent unintended movement of the frame member 10.

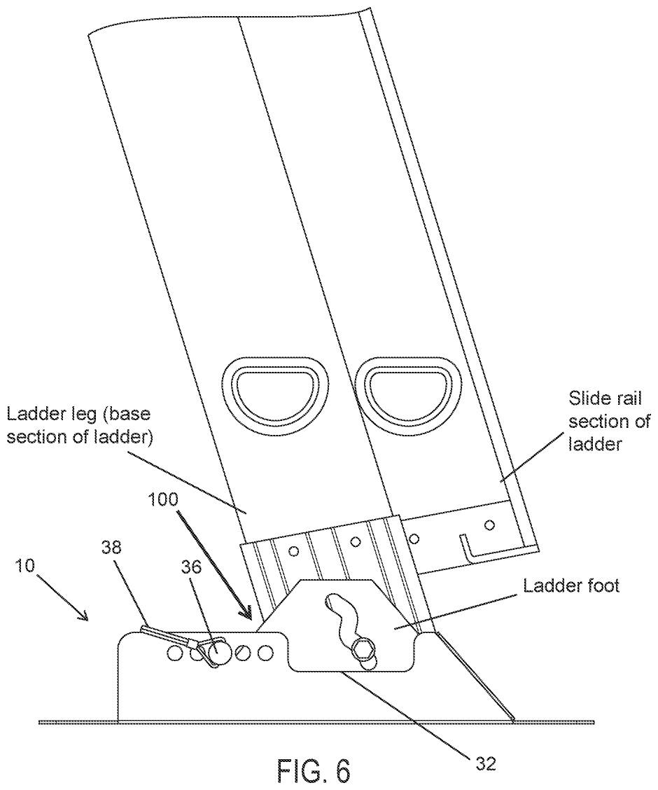

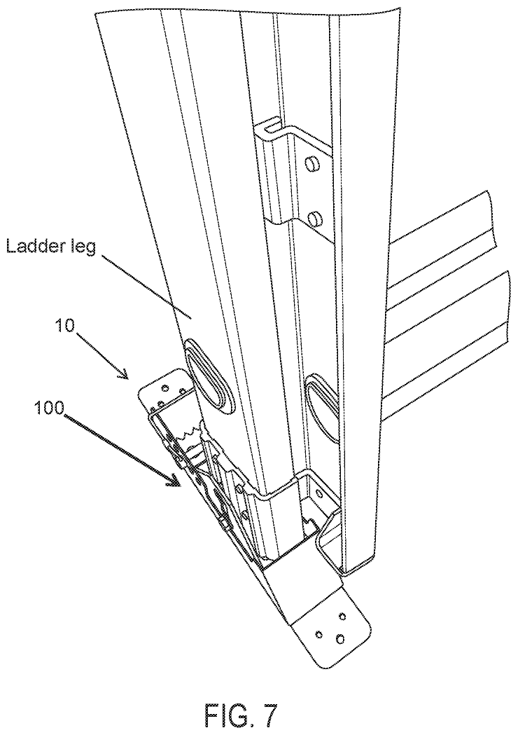

FIGS. 6 and 7 are side and perspective views illustrating coupling of the stabilization assembly to a ladder foot. As shown, the device is easy to install on each ladder foot. A user need only place the frame member 10 upon a ladder foot, slide the frame member 10 until the rear wall 22 contacts the ladder foot, and fasten a locking member 36 to the frame member 10. In particular, the locking member 36 may include a pin, bolt, or other fastener that passes through corresponding apertures of the side walls, such that the locking member extends across the cavity and retains the ladder foot within the cavity, thereby securing the frame member to the ladder foot. In some embodiments, the locking member may include a hitch pin or other form of safety pin 36 that is retained within the apertures via a wire snap 38. As illustrated, the row of apertures extend along a length of the side walls so as to accommodate different sizes of ladder feet, including any shoes attached thereto. Accordingly, when installing the device, a user need only set a hitch pin to the appropriate apertures on the side walls, which in turn secures the stabilization assembly to the ladder foot. The user can then set the ladder into position at a desired site, in which the user can easily fasten the stabilization assembly to surface under the ladder. The stabilization assemblies can be temporarily secured any type of solid surface, including concrete, wood decks, soil, and the like.

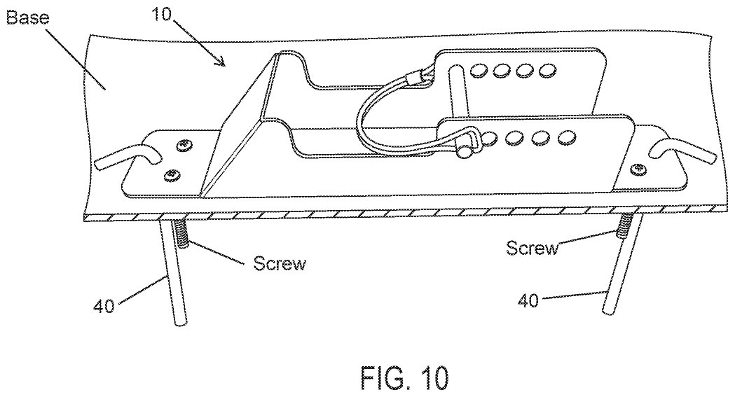

FIG. 10 is a perspective view of the stabilization assembly of FIG. 1 temporarily secured to a surface via one or more securing members. As shown, the securing member(s) may include, for example, a stake 40 for penetrating and securing the base member 12 (and thus the frame member 10) to soil, grass, sand, or other ground material. The stake 40 may be passed through aperture 28 on each end 14 and 16, for example. Additionally or alternatively, the securing member may include a screw or other fastener for penetrating other types of solid surfaces, such as concrete, stone, or wood and thus maybe passed through apertures 30 on each end 14 and 16 of the base member 12. In the event that the surface is concrete, a user may initially drill anchor holes and install anchors for receipt of a fastener.

Accordingly, the stabilization system of the present provides numerous advantages. The stabilization assemblies eliminate the need for someone to hold or otherwise foot the bottom of a ladder during use, and further eliminate the need for non-conventional methods to ladders in place. Furthermore, the stabilization assembly is relatively simple in design, in that the frame member is formed from a single sheet of material (preferably a rigid, durable metal, such as steel), wherein the side walls and rear walls are bent into place to thereby form the cavity. Accordingly, such a device is inexpensive to manufacture, as it requires no welding or other specific manufacturing techniques, thereby reducing the overall production costs. Furthermore, such a device is easy to install on each ladder foot. A user need only place the frame member upon a ladder foot, slide the frame member until the rear wall contacts the ladder foot, and fasten the locking member to the frame member (e.g., set a hitch pin to appropriate apertures on the side walls), thereby securing the stabilization assembly to the ladder foot. The user can then set the ladder into position at a desired site, in which the user can easily fasten the stabilization assembly to surface under the ladder. The stabilization assemblies can be temporarily secured any type of solid surface, including concrete, wood decks, soil, and the like.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. A ladder stabilization assembly comprising:
a frame member composed of a single sheet of material, the frame member comprising a base member and three walls extending therefrom to cooperatively form a cavity shaped and sized to receive a foot of a ladder; and
a locking member for releasably securing the ladder foot within the cavity of the frame member.

2. The ladder stabilization assembly of claim 1, wherein the base member is substantially planar and comprises opposing ends.

3. The ladder stabilization assembly of claim 2, wherein each opposing end of the base member comprises one or more apertures for receiving a respective securing member therethrough.

4. The ladder stabilization assembly of claim 3, wherein the securing member comprises a stake, pin, or fastener configured to penetrate at least one of a ground material, concrete material, and wood material.

5. The ladder stabilization assembly of claim 1, further comprising an anti-slip material provided on a bottom surface of the base member.

6. The ladder stabilization assembly of claim 5, wherein the anti-slip material comprises a polymer material.

7. The ladder stabilization assembly of claim 1, wherein the single sheet of material comprises a metal material.

8. The ladder stabilization assembly of claim 7, wherein the metal material comprises aluminum or steel.

9. The ladder stabilization assembly of claim 1, wherein the three walls comprise opposing side walls and a rear wall extending substantially perpendicular from the base member.

10. The ladder stabilization assembly of claim 9, wherein the rear wall is oriented at an acute angle relative to the base member.

11. The ladder stabilization assembly of claim 10, wherein the acute angle is between 45° and 50°.

12. The ladder stabilization assembly of claim 11, wherein the acute angle is approximately 48.6°.

13. The ladder stabilization assembly of claim 9, wherein each side wall comprises a set of apertures.

14. The ladder stabilization assembly of claim 13, wherein the set of apertures comprises a plurality of apertures aligned in a row and equidistantly spaced apart along an upper portion of the side wall.

15. The ladder stabilization assembly of claim 14, wherein the plurality of apertures extend along a horizontal plane that is substantially parallel to the base member.

16. The ladder stabilization assembly of claim 13, wherein the sets of apertures defined on the opposing side walls are substantially aligned with one another, such that individual apertures of the set of apertures of one side wall are in alignment with corresponding individual apertures of the set of apertures on the other side wall.

17. The ladder stabilization assembly of claim 16, wherein corresponding individual apertures on the side walls are configured to receive the locking member for releasably securing and retaining a ladder foot within the cavity of the frame member.

18. The ladder stabilization assembly of claim 17, wherein the locking member comprises a pin or bolt configured to pass through corresponding and aligned apertures of the side walls and thereby extend across the cavity and retains a ladder foot within the cavity.

19. The ladder stabilization assembly of claim 18, wherein the locking member comprises a safety pin retained within the apertures via a wire snap.

20. The ladder stabilization assembly of claim 19, wherein the locking member comprises a hitch pin.
